(19) United States
(12) Patent Application Publication
(10) Pub. No.: US 2024/0099267 A1
(43) Pub. Date: Mar. 28, 2024

(54) SHELL PART FOR HOOF BOOT

(71) Applicant: Vainica Oy, RIIHIMÄKI (FI)

(72) Inventors: Satu Vainikka, Läyliäinen (FI); Jiri Vainikka, Läyliäinen (FI)

(73) Assignee: Vainica Oy, RIIHIMÄKI (FI)

(21) Appl. No.: 18/344,086

(22) Filed: Jun. 29, 2023

(30) Foreign Application Priority Data
Aug. 5, 2022 (FI) U20224090

(51) Int. Cl. A01K 13/00

(52) U.S. Cl. CPC A01K 13/007

(57) ABSTRACT

The object of the present invention is a hoof boot shell part (1) comprising a base part (2), the lower surface of which (2a) is arranged to rest against a surface and the upper surface of which (2b) is arranged to receive the bottom of the hoof. A rim (3) is arranged to extend from the edge of the base part (2) and adapted in use to surround the hoof. Attached to the lower surface (2a) of the base part (2) is a bottom piece (10), which forms an area (10a) of the lower surface (2a) of the base part (2), which is harder compared with the hardness of the other material of the base part (2).

The object of the present invention is a shell part for a hoof boot, comprising a base part, the lower surface of which is arranged to rest against a surface and the upper surface of which is arranged to receive the bottom of the hoof, as well as a rim, which is arranged to extend from the edge of the base part and adapted in use to surround the hoof.

Such hoof boots are known, for example, from products manufactured by Vainica Oy and marketed under the Flex Hoof Boots trademark. In addition to the structure of the shell part mentioned above, which is well-known in itself, the hoof boot comprises fastening means, such as straps or belts that can be fitted around the lower part of the foot of a perissodactyl, such as a horse. Such fastening means can typically be attached to the members formed in connection with the rim.

Several similar hoof protectors are known on the market, but the basic principle of their structure is the same as in Vainica Oy's solution. However, the same properties are required in the well-known products, where the safety and health of the perissodactyl must be taken into account. Therefore, in such hoof boots, the material of the shell part, including the base part, must be suitable for the stride and anatomy of the animal's foot, and at the same time be sufficiently durable in wear-causing use. Similar hoof boots on the market today are made of thermoplastic polyurethane, i.e. TPU, which above all fulfills the safety and health requirements of perissodactyls. Hoof boots can be made from TPU, which is at the same time elastic in terms of the rim and the fastening means, fulfilling said safety and health requirements, and satisfactorily wear-resistant in terms of the base part. Other plastic or plastic mixture materials with similar properties can also be used.

In any case, the challenge in known solutions is the durability of the base part, whose surface that comes against the bottom, usually the ground, is subject to quite a lot of stress and wear.

The object of the present invention is to provide a shell part of the hoof boot that is more durable than the prior art solutions, while at the same time implementing the safety and health aspects of the perissodactyl and maintaining the maximum flexibility of the rest of the shell part.

The above-mentioned objective is achieved by the shell part for a hoof boot according to independent claim 1, where a bottom piece is attached to the bottom surface of the base part, forming on the bottom surface of the base part an area, which is harder compared with the hardness of the other material of the base part.

The above-mentioned objective is achieved with the solution according to the invention, where the surface of the base part is harder than the rest of the shell part.

This creates a more wear-resistant shell part in the area of the lower surface of the bottom piece.

Preferred embodiments of the invention are disclosed in the attached independent claims. They define, for example, the preferred position of the bottom piece in the base part, more specifically the hardness of the bottom piece and material thereof. In addition to this, preferred embodiments of the structure according to the invention are disclosed in the independent claims, for example the bottom piece can be an integral part of the base part or arranged detachably in the base part.

In the following, the invention is explained in more detail by referring to the attached drawings, where:

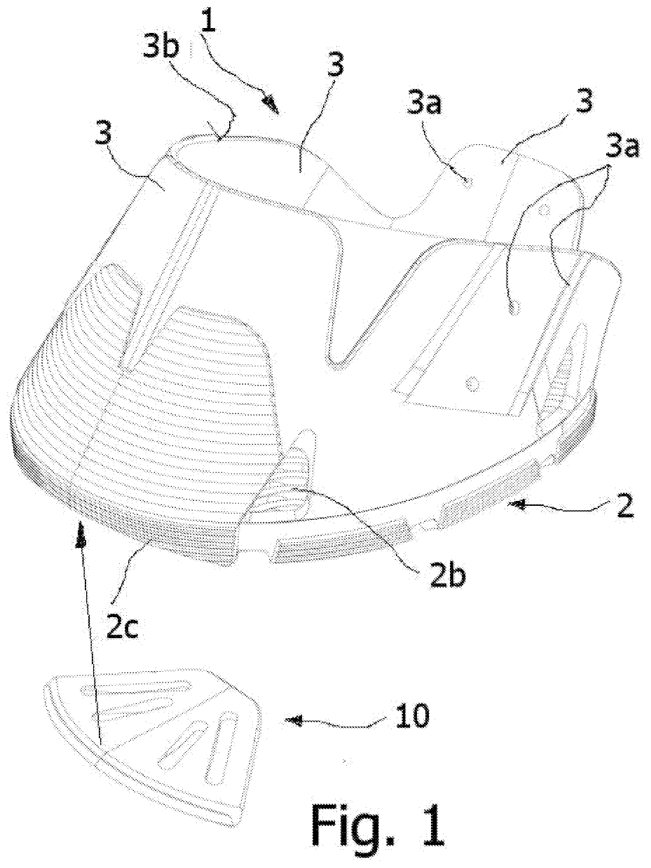

FIG. 1 shows axonometrically the hoof boot shell part according to a preferred embodiment of the invention,

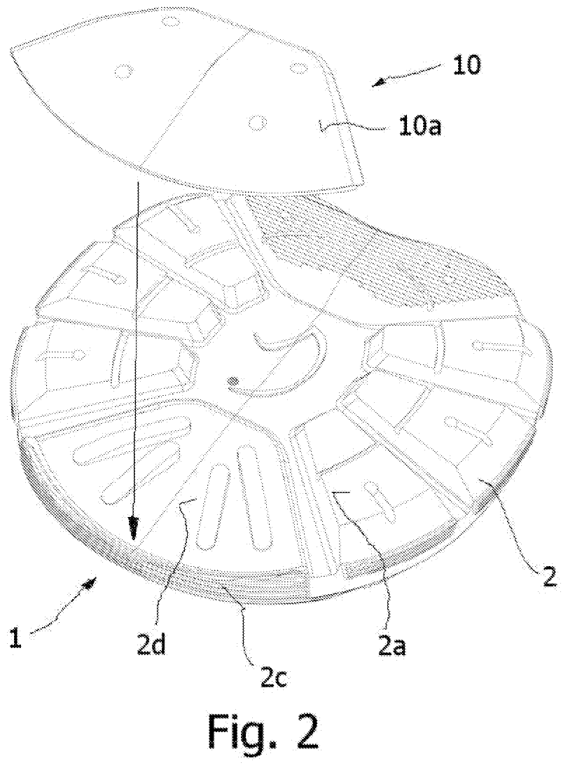

FIG. 2 shows the hoof boot shell part according to FIG. 1 as seen from below and the bottom piece detached, and

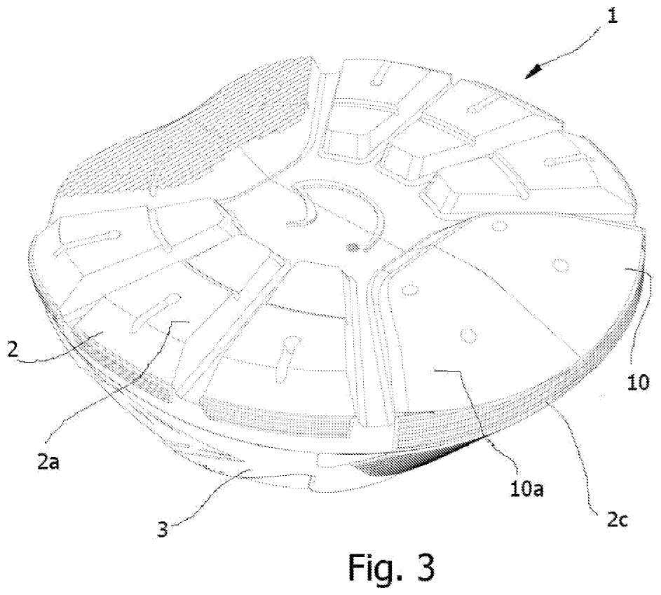

FIG. 3 shows the hoof boot shell part according to FIG. 2 with the bottom piece in place.

Shown in the figures is thus the hoof boot shell part according to the invention, which is marked with reference number 1. The hoof boot shell part 1 is a shoe-like element formed to fit around the hoof of a perissodactyl, such as a horse. It includes the base part marked with reference number 2 and the rim marked with reference number 3.

The base part 2 consists of the part that remains below the hoof in use, whose lower surface 2a is arranged to rest against a surface. The surface can be, for example, ground or a stable floor, in any case a surface on which the perissodactyl is able to walk. The upper surface 2b of the base part 2, which is on the opposite side and preferably in a substantially opposite direction to the lower surface 2a, is in turn arranged to receive the bottom of the hoof. Consequently, in use the base part 2 remains between the surface and the bottom of the hoof during the gait of the perissodactyl.

Rim 3 is in turn arranged to rise substantially upwards or obliquely upwards from the edge of the base part or from the area of the edge. Rim 3 is formed by a thin wall 3, the shape of which is, however, chosen in such a way that the hoof of the perissodactyl can be taken into the space defined by wall 3 and base part 2. The shape of upper edge 3b of rim 3 is preferably designed to follow the anatomy of the hoof area of the perissodactyl.

Rim 3 is equipped with members 3a, to which the hoof boot fastening means (not shown) intended for fixing the hoof boot in place can be connected. The fastening devices are strap-like and/or sock-like devices that can be placed around the lower part of the leg of a perissodactyl, taking anatomy into account. Members 3a are the slot-like area on the surface of the rim and the holes, to which the straps or the like can be attached, for example with rivets. Since this structure of hoof boot shell part 1 is known in itself, it will not be discussed in detail here.

The hoof boot shell part 1 disclosed above is preferably made of plastic or a mixture of plastics. In particular, the plastic material of the base part 2 and rim 3 is thermoplastic polyurethane, i.e. TPU. Especially in the hoof boot shell part application, hardness of the TPU is important for the reasons presented previously. Advantageously, the Shore hardness value here is 40-69 Shore. In this case, the method of measurement of hardness is preferably the Shore measurement intended for measuring the hardness of plastics. The material of the hoof boot shell part 1 can also be other than plastic or a mixture of plastics, the flexibility and hardness of which corresponds to the shell part 1 made of TPU disclosed above.

The lower surface 2a of base part 2 is provided with shaping such as grooves for better support and to prevent sliding on various surfaces such as riding tracks, offroad areas and paved roads.

Especially owing to the horse's gait, lower surface 2a is subjected to friction and various other forces against the ground that cause wear of lower surface 2a at different points. For this, formed on the lower surface 2a is area 10a, which is harder compared with the hardness of the other material of base part 2. This is formed by attaching bottom piece 10 to lower surface 2a of base part 2, forming the aforementioned area 10a of the lower surface 2a of base part 2. In particular, this area is formed by the lower surface of bottom piece 10. The material of the bottom piece is plastic or a mixture of plastics, preferably thermoplastic polyurethane, i.e. TPU. The Shore value of the hardness of the bottom piece 10 is preferably at least 70 Shore. The Shore value of the bottom piece can be, for example, 70-120 Shore, preferably 75-95 Shore. In other words, bottom piece 10 is harder material than base part 2. Although certain Shore values are presented here for bottom piece 10 and base part 2, they are not necessarily limiting. The relative hardness, i.e. the hardness of the bottom piece (Shore values) in relation to the hardness of the base part can also be expressed as their relative value, which is preferably 1.1-2.0 (the ratio of the Shore hardness value of the bottom piece to the Shore hardness value of the base).

It deserves to be mentioned here that, depending on the material of bottom piece and/or base part 2, the hardness is determined by at least one of the following hardness measurement methods: Shore measurement, Rockwell measurement, Vickers measurement, Brinell measurement, Leeb hardness test.

This kind of bottom piece 10 therefore forms a kind of wearing part, which is designed to withstand the stress of use better than lower surface 2a of base part 2. Thus, a higher usage time is also achieved for the entire hoof boot shell part 1.

Bottom piece 10 is thus preferably located in front part 2c of base part 2. A bottom place located at this point can also be called a tip piece. Of course, bottom piece 10 can be located elsewhere, but wear is greatest in the area of front part 2c, in which case it is advantageous to choose the location of the bottom piece at least there. There can also be several bottom pieces in base part 2, and they can be of different shapes and sizes in relation to each other, but the figures show an embodiment where there is one bottom piece 10 (tip piece) placed in front part 2c of base part 2.

Bottom piece 10 can be permanently fixed to base part 2. In this case, bottom piece will be cast in connection with the manufacture of shell part 1 into shaping 2d on lower surface 2a of base part 2, as shown in FIG. 2. Bottom piece 10 can also be welded to base part 2. These methods are advantageous especially when base part 2 and the bottom piece are made of TPU. In any case, bottom piece 10 can be adjusted in place so that lower surface 2a of base part 2 and lower surface 10a of bottom piece 10 form a uniform surface having the desired surface design, such as the grooves mentioned above. It is possible that bottom piece 10 is made of another material, such as, for example, metal, metal alloy, carbon fiber composite or glass fiber composite.

It is also possible that bottom piece 10 is detachably fixed to base part 2. In this case, bottom piece 10 can be placed in contouring 2d of base part 2 with a form-locking joint. This can be a tongue-and-groove mechanism between the bottom piece 10 and base part 2, not shown in the figures, which can be implemented by shaping the appropriate parts of bottom piece 10 and base part 2 to accomplish a form-locking structure. Alternatively, mechanical connection means, such as screws or rivets can be used.

1. A hoof boot shell part (1) comprising a base part (2), the lower surface of which (2a) is arranged to rest against a surface and the upper surface of which (2b) is arranged to receive the bottom of the hoof, as well as a rim (3), which is arranged to extend from the edge of the base part (2) and adapted in use to surround the hoof, characterized in that attached to the lower surface (2a) of the base part (2) is a bottom piece (10), which forms an area (10a) of the lower surface (2a) of the base part (2), which is harder compared with the hardness of the other material of the base part (2).

2. The hoof boot shell part (1) according to claim 1, characterized in that the bottom piece (10) is located on the front part (2c) of the base part (2).

3. The hoof boot shell part (1) according to claim 1, characterized in that the material of the base part (2) and the rim (3) is thermoplastic polyurethane (TPU) having a Shore hardness value of 40-69 Shore.

4. The hoof boot shell part (1) according to claim 1, characterized in that the material of the bottom piece (10) is plastic or a mixture of plastics, preferably thermoplastic polyurethane (TPU) having a Shore hardness value of at least 70 Shore.

5. The hoof boot shell part (1) according to claim 1, characterized in that the bottom piece (10) is permanently fixed to the base part (2).

6. The hoof boot shell part (1) according to claim 1, characterized in that the bottom piece (10) is detachably fixed to the base part (2) either with a form-locking joint or with mechanical joints.

7. The hoof boot shell part (1) according to claim 1, characterized in that the rim (3) of the hoof boot shell part (1) is provided with members (3a), to which the fastening means intended for fixing the hoof boot in place can be attached.

8. The hoof boot shell part (1) according to claim 1, characterized in that the lower surface (2a) of the base part (2) comprises a shaping (2d), to which the bottom piece (10) can be fitted so that a uniform surface is formed from the lower surface (2a) of the base part (2) and the lower surface (10a) of the bottom piece (10a).

9. The hoof boot shell part (1) according to claim 2, characterized in that the material of the base part (2) and the rim (3) is thermoplastic polyurethane (TPU) having a Shore hardness value of 40-69 Shore.

10. The hoof boot shell part (1) according to claim 2, characterized in that the material of the bottom piece (10) is plastic or a mixture of plastics, preferably thermoplastic polyurethane (TPU) having a Shore hardness value of at least 70 Shore.

11. The hoof boot shell part (1) according to claim 3, characterized in that the material of the bottom piece (10) is plastic or a mixture of plastics, preferably thermoplastic polyurethane (TPU) having a Shore hardness value of at least 70 Shore.

12. The hoof boot shell part (1) according to claim 4, characterized in that the bottom piece (10) is permanently fixed to the base part (2).

13. The hoof boot shell part (1) according to claim 4, characterized in that the bottom piece (10) is detachably fixed to the base part (2) either with a form-locking joint or with mechanical joints.

14. The hoof boot shell part (1) according to claim 4, characterized in that the rim (3) of the hoof boot shell part (1) is provided with members (3a), to which the fastening means intended for fixing the hoof boot in place can be attached.

15. The hoof boot shell part (1) according to claim 4, characterized in that the lower surface (2a) of the base part (2) comprises a shaping (2d), to which the bottom piece (10) can be fitted so that a uniform surface is formed from the lower surface (2a) of the base part (2) and the lower surface (10a) of the bottom piece (10a).

16. The hoof boot shell part (1) according to claim 9, characterized in that the material of the bottom piece (10) is plastic or a mixture of plastics, preferably thermoplastic polyurethane (TPU) having a Shore hardness value of at least 70 Shore.

17. The hoof boot shell part (1) according to claim 11, characterized in that the bottom piece (10) is permanently fixed to the base part (2).

18. The hoof boot shell part (1) according to claim 11, characterized in that the bottom piece (10) is detachably fixed to the base part (2) either with a form-locking joint or with mechanical joints.

19. The hoof boot shell part (1) according to claim 11, characterized in that the rim (3) of the hoof boot shell part (1) is provided with members (3a), to which the fastening means intended for fixing the hoof boot in place can be attached.

20. The hoof boot shell part (1) according to claim 11, characterized in that the lower surface (2a) of the base part (2) comprises a shaping (2d), to which the bottom piece (10) can be fitted so that a uniform surface is formed from the lower surface (2a) of the base part (2) and the lower surface (10a) of the bottom piece (10a).
